(19) United States
(12) Patent Application Publication
(10) Pub. No.: US 2012/0136701 A1
(43) Pub. Date: May 31, 2012

(54) Method and system for faciliating interactive commercials in real time

(76) Inventors: Rohan Relan, Atherton, CA (US); Samantha Margaret John, Brooklyn, NY (US)

(21) Appl. No.: 13/373,695

(22) Filed: Nov. 25, 2011

Related U.S. Application Data
(60) Provisional application No. 61/458,574, filed on Nov. 26, 2010.

(51) Int. Cl. G06Q 30/02

(52) U.S. Cl. 705/14.4

(57) ABSTRACT

The present invention discloses a method and a system for facilitating interactive commercials to users. The invention includes a client in the form of an application running on a display device and a server. The client may be in the form of a TV operating system. The method includes extracting audio from a commercial and generating a fingerprint from the extracted audio. The fingerprint as generated is sent by the client to the server. The server includes a database of commercials. After receiving the fingerprint, the server performs matching of the fingerprint with a set of commercials present in the database. Based on the match found, the server displays results. If a match is found, the server sends one or more instructions to the client device to initiate the interactive flow. Otherwise, the server returns an empty string.

### CROSS REFERENCE TO RELATED APPLICATION

This application claims the benefit of U.S. provisional application 61/458,574, filed Nov. 26, 2010, which is incorporated by reference herein.

### FIELD OF THE INVENTION

The present invention relates, in general, to the field of commercials or advertisements. More specifically, the invention relates to a method and a system for facilitating interactive commercials.

### BACKGROUND

Entities such as organizations, corporate houses, and enterprises aim to create a distinct place for themselves in the current competitive market. To achieve this, most of these entities are majorly dependent on advertisements (ads) or commercials to promote their businesses. Commercials assist such entities in effective product placement, marketing, promotion, sponsorship, brand development, corporate identity formation, and user awareness. This market strategy yields huge profits to the entities and helps them to capture potential clients/businesses. During the initial stages, this marketing strategy requires huge investments from such entities. However, post implementation, it transforms into a major source of revenue generation. Thus, commercial advertising has gained a tremendous importance and popularity in today's competitive world.

A number of advertising mediums, including Television (TV) commercials, Internet commercials, banner commercials, e-mail ads, and mobile commercials, are available. Of these, TV commercials are one of the most effective and widespread advertising mediums to promote any business, organization, or a corporate house. TV commercials have several advantages since TV reaches almost every household and it registers in audience's mind more effectively than any other medium. Additionally, TV commercials have a visual appeal and music to stimulate viewers/users emotionally.

A number of methods and solutions are available for providing different types of commercials on Television. These solutions primarily focus on displaying commercials in the form of a video. In some cases, the advertisers may sometime display contact numbers of the advertisers with directions to call, or send a text message or provide Web addresses to buy the product online. However, one of the disadvantages with such known solutions is that they do not facilitate any provision that allows the users to interact in real time with a particular commercial being watched. Further, these solutions fail to display such content in the commercials that allow the users to perform desired actions. For example, a user cannot easily buy a product that he or she likes while watching the commercial without making an extra effort. Additionally, these solutions do not allow the users to customize the commercials according to their needs.

In view of the aforesaid reasons, there exists a need for a method and a system for providing interactive commercials for users. The method and the system should enable the users to perform one or more actions in real-time. Moreover, there exists a need for a method and a system for providing such interactive content to the users so as to allow them to navigate through the commercial. In addition to this, there further exists a need for a method and a system enabling the users to customize the commercials based on their requirements.

### SUMMARY OF THE INVENTION

Various embodiments of the present invention provide a method and a display device for providing interactive commercials for viewers/users. The display device includes a sampling module, a fingerprinting module and a display module. The sampling module samples data from a commercial displayed to a user. The data may include audio, video, text or a combination of audio, video and text. The sampled data is provided to the fingerprinting module. The fingerprinting module generates a fingerprint of the sampled data and sends the fingerprint to the matching module. An interactive content is displayed with the commercial by the display module. The interactive content is extracted based on the generated fingerprint.

The method includes sampling data from a commercial displayed to a user and generating a fingerprint of the sampled data. Further, matching of the generated fingerprint with a plurality of fingerprints corresponding to a plurality of commercials is performed. If the fingerprint matches, a matching fingerprint is obtained. Otherwise, an empty string is returned. Thereafter, an interactive content associated with the matching fingerprint is extracted and is displayed with the commercial.

An objective of the present invention is to provide one or more applications for the user's display device and subsequently install them. The applications are discovered when the user interacts with the display device. Further, the applications may be mobile apps and the like.

Another objective of the present invention is to provide live content to user's display device based on the program he/she is watching.

A further objective of the present invention is to provide coupons to the user for the items, such as discount coupons, which she or he wishes to purchase.

Yet another objective of the present invention is to enable the user to enter a contest to win one or more exciting prizes.

Another objective of the present invention is to enable the user to vote for contestants in a dancing & singing competition in TV shows.

An additional objective of the present invention is to enable the user to fill out surveys to provide information to advertisers and service providers.

### BRIEF DESCRIPTION OF THE DRAWINGS

Various embodiments of the invention will hereinafter be described in conjunction with the appended drawings provided to illustrate, and not to limit, the invention, wherein like designations denote like elements, and in which:

FIG. 1 represents an exemplary environment in which various embodiments of the invention may be practiced;

FIG. 2(a) shows a block diagram illustrating the display device 104 of FIG. 1 for providing interactive commercials to users, in accordance with an embodiment of the invention;

FIG. 2(b) shows a block diagram illustrating the server 106 of FIG. 1 for providing interactive commercials to users, in accordance with an embodiment of the invention;

FIG. 3(a) is a flowchart depicting a method for providing interactive commercials to users, in accordance with an embodiment of the invention;

FIG. 3(b) is a flowchart depicting a method for providing interactive commercials to users, in accordance with another embodiment of the invention;

FIG. 4 shows an exemplary diagram depicting a pop-up menu with one or more special offers, in accordance with an embodiment of the invention;

FIG. 5 demonstrates another exemplary diagram depicting a pop-up menu with one or more special offers, in accordance with an embodiment of the invention;

FIG. 6 is an exemplary depiction of a pop-up menu with one or more options, in accordance with an embodiment of the invention; and

FIG. 7 represents another exemplary depiction of a pop-up menu having one or more options, in accordance with an embodiment of the invention.

### DETAILED DESCRIPTION OF THE INVENTION

The main objective of the present invention is to provide interactive commercials to users in real-time. Users are able to view commercials using a display device. Various examples of the display device may include devices such as Internet-enabled Television, Internet Protocol Television (IPTV), a computer, and a Set Top Box (STB). The interactive commercials enable the users to view additional information or various options, and allow the users to navigate through the options displayed on the device. Examples of various options may include, but are not limited to, coupons, websites, mobile apps, a poll question, offer to launch application, and other similar media content.

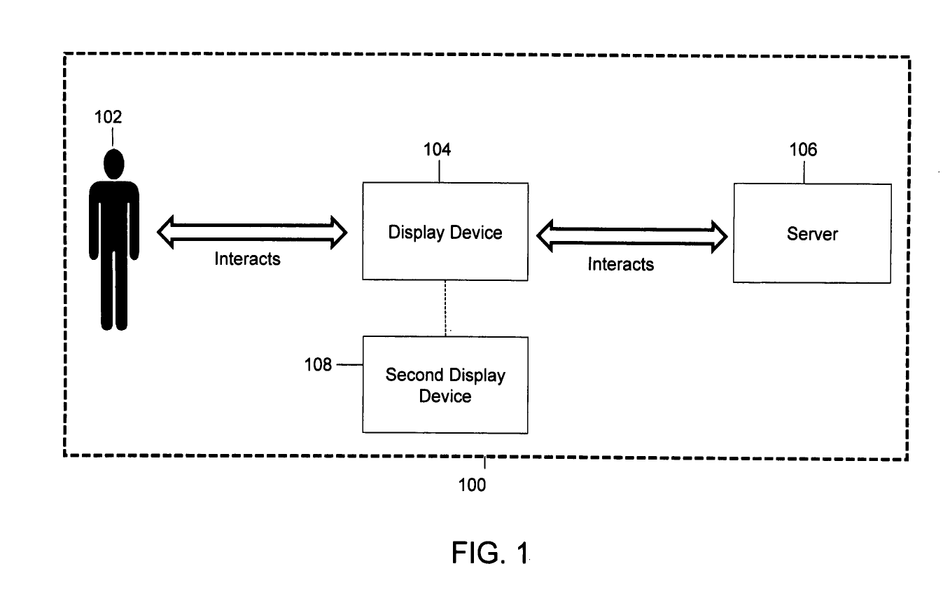

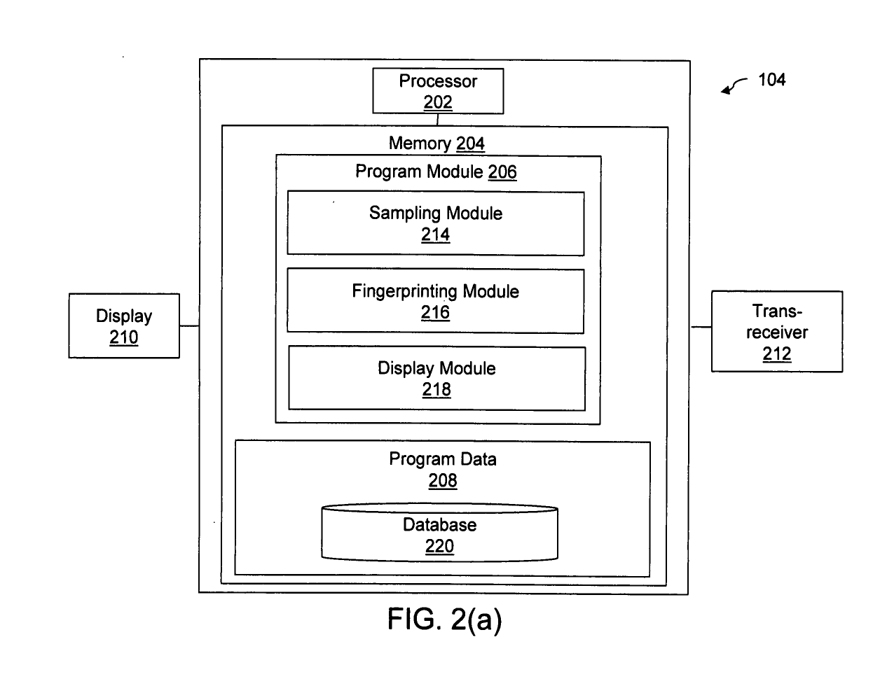

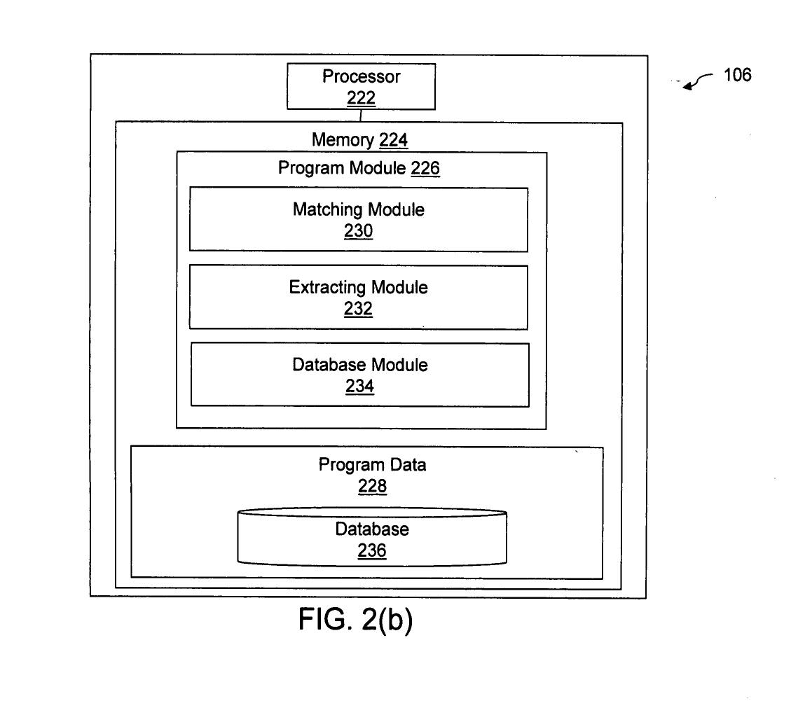

FIG. 1 represents an exemplary environment 100 in which various embodiments of the invention may be practiced. To describe the exemplary environment as illustrated in FIG. 1, references will be made to FIG. 2, although it will be apparent to those skilled in the art that the implementation details of the environment can be applicable to any other embodiment of the present invention.

Environment 100 is shown to include a user 102 (a viewer), a display device 104, and a server 106. Display device 104 is communicatively coupled with user 102 and server 106.

In accordance with an embodiment of the present invention, environment 100 may be implemented as a “client-server” architecture.

In accordance with a preferred embodiment of the present invention, display device 104 is also referred to as a client device. The client device includes an application built on its operating system. Examples of various display devices 104 may include, but are not limited to, Internet-enabled TV, Internet Protocol Television (IPTV), a cable TV, a direct-to-home TV, a Set-Top-Box (STB), a personal computer, laptop computers, and a Video on Demand (VoD) device.

In accordance with further embodiment of the invention, display device 104 may include an Operating System (OS) or a middleware. Examples of various Operating System (OS) platforms may include, but are not limited to, Microsoft Windows, Linux, Unix, Sun Solaris, Hewlett Packard UniX (HP-Unix®), and Advanced Interactive eXecutive (IBM AIX). Various examples of middleware may include Trickplay and Android. Additionally, display device 104 is used to display commercials to user 102. It should be noted that the “type” of display devices and their operating systems/middleware are not essential to the functioning of the present invention. The present invention will be applicable to other devices as well.

In accordance with an embodiment of the present invention, server 106 includes a database of commercials. The database of commercials stores a set of fingerprints corresponding to a set of commercials. As known in the art, a fingerprint represents a signal for a file. The fingerprint contains adequate information to distinguish a file from another file. In accordance with an embodiment of the present invention, the fingerprints may be generated by implementing one or more methods known in the art.

One or more commercials are displayed on display device 104 for user 102 to view. Display device 104 extracts data from a commercial displayed on it. In an embodiment of the present invention, the display device 104 extracts audio from a commercial displayed on it. Thereafter, display device 104 generates a fingerprint of the commercial using the extracted audio. The fingerprint is generated in a predefined segment size. The predefined segment size may include 3 seconds segment, 4 seconds segment, 5 seconds segments, 7 second segments, and the like. In accordance with various embodiments of the present invention, the predefined segment size may vary based on the quality of audio, required accuracy to identify the commercial, and an acceptable amount of delay for identifying the commercial. Further, higher accuracy requires a larger segment size, while lower acceptable delay may require a smaller segment size. Also, noisy audio may require a larger segment size. In accordance with another embodiment of the present invention, display device 104 may also extract video, text, data or a combination of video, audio, text or data from the commercial displayed on it. The fingerprint as generated is sent to server 106.

At server 106, the received fingerprint is matched with all available fingerprints within the database of commercials. If the fingerprint does not match, server 106 returns an empty string to display device 104. As a result, no additional information is sent to the display device 104. However, if a match is found, server 106 sends one or more instructions to display device 104. The instructions may represent an interactive content. The instructions sent by server 106 facilitate interaction of user 102 with the commercial being displayed on display device 104. In other words, user 102 is enabled to interact with the commercial on display device 104 based on the received instructions. User 102 may continue further interaction with the commercial using a remote control of display device 104 (if applicable), mobile phones, keyboard, and the like. As a result of the interaction, display device 104 or server 106 performs the desired actions as requested by user 102.

Thereafter, display device 104 resumes sampling audio for the subsequent commercials displayed on display device 104 and, thus, repeat the cycle.

In accordance with an embodiment of the present invention, the client 102 may be in the form of an application built on the display device 104 operating system. The client 102 performs sampling of the audio of the commercial using Application Program Interface (API) calls from the operating system on the display device and generates the fingerprint of the sampled audio.

In accordance with another embodiment of the present invention, the instructions may be sent to a second display device 108. The second display device 108 may correspond to a device other than the display device 104 on which the user is watching the commercial. The second display device 108 may include laptop computers, mobile phones, PDA, smart phones, and the like. Sending the instructions on the second display device 108 has a number of advantages. For example, it allows the user to input or view the information easily; enhances the mobility of the user; and provides ease of interactivity with the commercial.

In accordance with an embodiment of the present invention, the database of commercials is described herein. The database of commercials maintains a variety of commercials relating to eating joints, restaurants, hotels, electronic items, entertainment devices, merchandise, stationeries, airlines, jewelry items, jobs, movies, music, songs, plays, and so forth. The commercials in the database may be maintained in a predefined format. Various examples of the predefined format may include, but are not limited to, MP3, WMA, WAV, DCT, AAC, RA, AIF, and MPEG. These predefined formats of commercials are well known in the art. Additionally, it should be noted that the format of storing the commercials is not essential to the functioning of the present invention. The present invention will be applicable for all types of formats for storing the commercials. In accordance with an embodiment of the present invention, the database of commercials maintains fingerprints of various types of commercials, thereby allowing rapid identification of the fingerprint of the commercial displayed on display device 104.

In accordance with an embodiment of the present invention, display device 104 is configured to understand the instructions or commands sent by server 106. Accordingly, display device 104 communicates with server 106 at predefined points in the interaction. The predefined points may correspond to the points when user 102 responds to the instructions sent by server 106. This will further be explained with the help of an example. In accordance with this example, it can be assumed that server 106 recognizes a Domino's commercial and sends instructions to user 102 asking if he/she would like to see the locations of the Domino's in his/her area. In case user 102 responds with “yes”, display device 104 sends this response to server 106. Accordingly, server 106 first determines the user's location, which user 102 has input through his/her zip code, or server 106 determines the user's location automatically via an IP (Internet Protocol) address. Accordingly, server 106 finds a list of locations of the Domino's in the area of user 102. Subsequently, server 106 responds to display device 104 with the list of the local Domino's in the area, which display device 104 shows to user 102.

In accordance with an embodiment of the present invention, display device 104 may continuously send the fingerprints to server 106 to synchronize media content and the commercials being displayed on display device 104. The synchronization is desirable so that server 106 can provide interactive content that is synchronized with the commercial displayed on display device 104. For example, when “soap” is displayed during a commercial, the interactive content related to the soap should be displayed at the same moment on display device 104.

Various examples of networks through which display device 104 and server 106 can exchange information or data between themselves can be the Internet, Local Area Network (LAN), Wide Area Network (WAN), a Wireless LAN, Metropolitan Area Network (MAN), Public Switched Telephone Network (PSTN), a global Telecommunications Exchange (TELEX) network, a Global System for Mobile (GSM) communication network, a Code Division Multiple Access (CDMA) network, a satellite network, a wireless network, a wired line network, a digital television network, and other similar networks. In addition to this, display device 104 and server 106 in the network can communicate with each other using various network topologies such as Transport Control Protocol (TCP), Internet Protocol (IP), User Datagram Protocol (UDP), Simple Mail Transport Protocol (SMTP), Session Initiation Protocol (SIP), Post Office Protocol (POP), and other protocols that are well known in the art.

For one ordinarily skilled in the art, it is understood that the steps implemented by the elements described above are exemplary in nature and are simply used to facilitate the description of FIG. 1. The steps described above may be implemented by any of the elements as shown in the figure. Accordingly, it is clear that that the invention is not limited to the embodiment described herein.

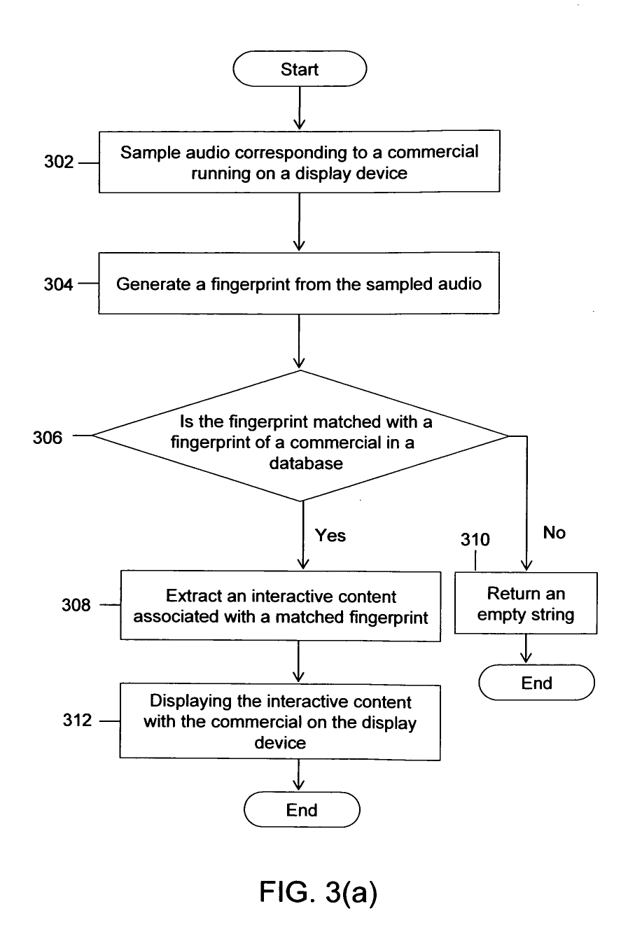

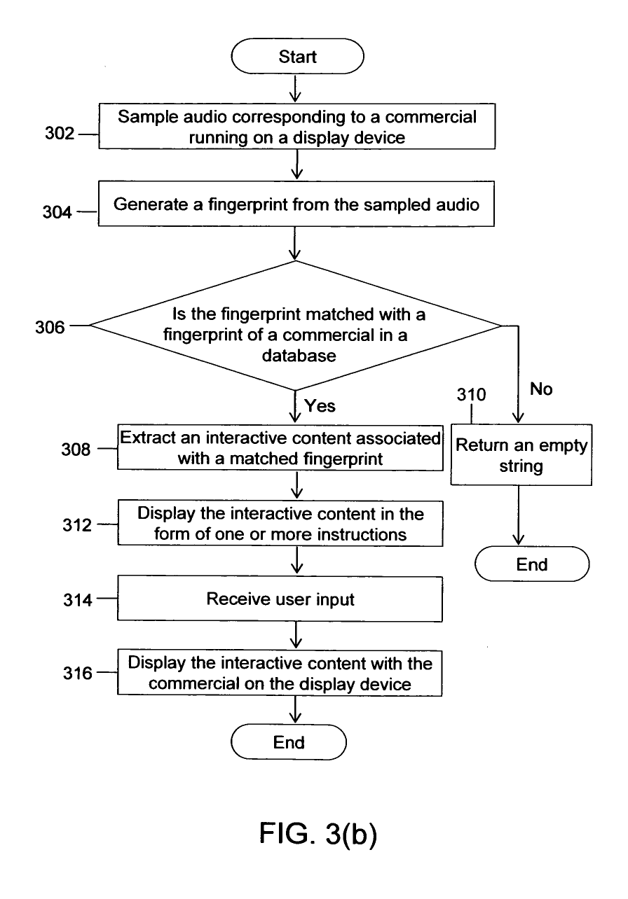

FIG. 2(a) shows a block diagram illustrating the display device 104 of FIG. 1 for facilitating interactive commercials to users, in accordance with an embodiment of the invention. To describe the system modules illustrated in FIG. 2(a), references will be made to FIGS. 1, 3(a) and 3(b), although it will be apparent to those skilled in the art that the implementation details of the system modules can be applicable to any other embodiment of the present invention.

The display device 104 includes a processor 202 coupled to a memory 204. Memory 204 includes one or more program modules 206 and program data 208. Processor 202 executes instructions stored in program module 206 and stores one or more variables in program data 208. Program module 206 includes a sampling module 214, a fingerprinting module 216 and a display module 218. Program data 208 includes a database 220.

Display device 104 further includes a display 210 for displaying commercials. Display 210 corresponds to a display screen capable of presenting contents to a user. Examples of the display screen includes, but not limited to, a cathode ray tube display, liquid crystal display, electro luminescent display, plasma display, etc.

Initially, a user such as user 102 watches a program on a device such as display device 104. During the program, a commercial is displayed on display 210. At the same time the user is watching the commercial, sampling module 214 samples an audio from the commercial in real time. The audio is sampled for predefined time intervals of audio, as described with reference to FIG. 1.

In accordance with another embodiment of the present invention, sampling module 214 may sample video, text, data, or a combination of video, text, and data, from the commercial displayed on the device.

After sampling the audio from the commercial, sampling module 214 sends the sampled audio to fingerprinting module 216. Fingerprinting module 216 generates an audio fingerprint. As known in the art, an audio fingerprint represents an audio signal for an audio file. The fingerprint contains adequate information to distinguish the audio file from another audio file. In accordance with an embodiment of the present invention, the audio fingerprint may be generated by implementing one or more methods known in the art. Once the audio fingerprint is generated, display module 218 displays an interactive content associated with the commercial on display 210.

FIG. 2(b) shows a block diagram illustrating server 106 of FIG. 1 for facilitating interactive commercials to users, in accordance with an embodiment of the invention. To describe the system modules illustrated in FIG. 2(b), references will be made to FIGS. 1, 2(a), 3(a) and 3(b), although it will be apparent to those skilled in the art that the implementation details of the system modules can be applicable to any other embodiment of the present invention.

Server 106 includes a processor 222 coupled to a memory 224. Memory 224 includes one or more program modules 226 and program data 228. Processor 222 executes instructions stored in program module 226 and stores one or more variables in program data 228. Program module 226 includes a matching module 230, an extracting module 232 and a database module 234. Program data 228 includes a database 236.

Matching module 230 receives the fingerprint generated by fingerprinting module 216 (as shown in FIG. 2(a)) and interacts with database module 234 to find a matching fingerprint of the audio fingerprint in database 236. In accordance with an embodiment of the present invention, matching module 230 may implement one or more methods that are well known in the art for pattern matching or fingerprint matching.

If a match is found, matching module 230 sends the matching fingerprint to extracting module 232. Thereafter, extracting module 232 extracts the interactive content associated with the matching fingerprint and sends the interactive content to display module 218 (as shown in FIG. 2(a)). Then, display module 218 displays the interactive content with the commercial being displayed on display 210. The identified commercial with the interactive content then becomes an interactive commercial. In accordance with an embodiment of the present invention, the interactive content may be displayed on display device 104 with the commercial based on the type of commercial, profile of the user, historic preferences of the user, demographic information of the user, location of the user, current activity of the user, product history of the user, commercials the user has previously interacted with, survey results from the user, user's commercial preferences (i.e., when receiving interactive content, the application asks the user if the commercial is relevant to them), other programs currently playing on the display device, and the revenue generated by various interactive advertisements (i.e., higher revenue generating advertisements are more likely to be displayed), and so forth. Hence, display module 218 enables the user to view the interactive commercial on the display device.

If no match is found, matching module 230 returns an empty string to extracting module 232. Subsequently, display module 218 displays the commercial without adding any additional information or the interactive content.

In accordance with an embodiment of the present invention, the interactive content, as described above, may be sent to the user in the form of one or more instructions. The instructions may contain one or more fields specifying commands and other fields specifying inputs to parameters to be filled by the user. According to this embodiment, the instructions may be defined in a predefined format, such as Java Script Object Notation (JSON), JSON-RPC, XML-RPC, and XML. In further accordance with this embodiment, the display device may be configured to understand a particular set of commands. The commands may be sent in the form of one or more instructions. Various examples of the instructions may include, but are not limited to: displaying text/image; prompting the user from a list of options; prompting the user for free-form input; capturing information about the current state of the display device such as its location and current channel; installing an application; initiating a call; sending a text/email message; and calling out to a third-party API. It should be noted that the commands as described herein are exemplary in nature and are simply used to facilitate the description of the present invention. The commands may change, depending upon the specific embodiment of the invention.

In accordance with an embodiment of the present invention, various examples of instructions have been described herein. In one example, an instruction asking “Would you like to have a free sample of hair conditioner?” may be displayed to the user on TV. If user selects “yes”, further instructions may be displayed to the user asking “what is your favorite hair conditioner?” With this question, various options can be displayed to the user indicating the available brands such as “L'oreal”, “Garnier”, and “Fiama Di Wills”. If the user selects “L'oreal”, a free sample of this conditioner may be delivered to the user's home address. Alternatively, a coupon for a free sample of conditioner may be sent to the user either through the email or through the mobile phone. Subsequently, the user can get a free sample of conditioner by showing the coupon to a merchant.

In accordance with an embodiment of the present invention, the interactive commercial may be customized by the users. The users may customize the commercial based on their needs. In one example, the user can change the appearance of the interactive content displayed with the commercial. For instance, the user can customize one or more parameters such as text size, text color, and icons. In another example, the user can change the frequency of the display of one or more commercials. In a further example, the user can customize the default input values shown in the interactive content of the commercial. The input values may include e-mail address, physical address, telephone number, location, and the like. Additionally, the user can change the preferences to show the interactive content he/she likes to view. For instance, the user may like to view only “show coupons” for food.

In accordance with an embodiment of the present invention, the one or more modules as shown in FIG. 2(a) and FIG. 2(b) may correspond to software components. In accordance with another embodiment of the present invention, the one or more modules may correspond to hardware components with software modules running within the hardware components. In accordance with one more embodiment of the present invention, the one or more modules may be a combination of software modules and hardware modules.

In accordance with an embodiment of the present invention, the methodology as disclosed above is capable of matching an audio extracted from a commercial from one audio source (such as Mac) with another audio file of the same commercial taken from a different audio source (PC HD antennae). Thus, the audio source for extracting the commercial does not limit the scope of the invention.

FIG. 3(a) is a flowchart depicting a method for providing interactive commercials to users, in accordance with an embodiment of the invention. To describe the flowchart illustrated in FIG. 3, references will be made to FIGS. 1, 2(a) and 2(b), although it will be apparent to those skilled in the art that the implementation details of the flowchart can be applicable to any other embodiment of the present invention.

Initially, a user such as user 102 watches a program on a device such as a display device 104. The program displayed on the device may include live broadcast, reality program, play, movie, musical, and show. The program is interrupted by one or more commercials. In accordance with a preferred embodiment of the present invention, the display device includes an Internet-enabled Television or Internet Protocol Television (IPTV).

At 302, an audio sample is generated from the commercial running on the display device. In accordance with an embodiment of the present invention, at least one of video, audio, text, data or a combination of these may be generated from the commercial. The audio sample is generated in a predefined segment size, such as 30 seconds segments. Thereafter, at 304, the audio sample is further used to generate an audio fingerprint.

Then at 306, the fingerprint, as generated, is matched with one or more commercials present in a database of commercials. Based on the match performed, the output in terms of ‘yes’ or ‘no’ is returned to server 106. If no match for the fingerprint is found, then at 308 server 106 returns an empty string to display device 104. However, if a match for the fingerprint is found, then at 310, the matching fingerprint is obtained and an interactive content associated with the matching fingerprint is extracted. At 312, the interactive content is then displayed with the commercial on display device 104.

FIG. 3(b) is a flowchart depicting a method for providing interactive commercials to users, in accordance with another embodiment of the invention. The steps shown in the flowchart of FIG. 3(b) are identical to those shown in the flowchart of FIG. 3(a) except for the step 312 which has been omitted and steps 314-318 which have been added. In FIG. 3(b), after the extraction of the interactive content associated with the matching fingerprint at 310, the interactive content is displayed on the display device in the form of one or more instructions at 314. Thereafter at 316, an input is received from the user. Subsequently, at 318 the interactive content is displayed with the commercial on the display device. Accordingly, the interactive content containing the instructions initiates the interaction of the user with the commercial displayed on the display device.

In accordance with an embodiment of the present invention, the instructions may display one or more coupons to the user on the display device. In accordance with another embodiment of the present invention, the instructions may display a pop-up prompting the user to enter his/her email address or mobile number. After entering the desired information, the user may further receive email or Short Message Service (SMS) with a coupon.

In accordance with an embodiment of the present invention, the instructions may be displayed on a device other than the display device on which the commercial is displayed. Various examples of such devices may include, but are not limited to, mobile phones, personal computer, smart phones, and laptop computers.

In accordance with an embodiment of the present invention, the instructions displayed on the device may include one or more coupons. The coupons may be delivered to the user through email, or SMS. In accordance with another embodiment of the invention, the instructions displayed on the device may include a poll question to be answered by the user. In accordance with this embodiment of the present invention, the instructions may relate to displaying of another program on the display device. The user can automatically record the instructions on a DVR. In accordance with a further embodiment of the present invention, the instructions displayed on the device may include information about a product or a company. The information may be delivered to the user by at least one of email and SMS. In accordance with one more embodiment of the present invention, the instructions may include an offer to launch another application on the display device the user is using. In accordance with an additional embodiment of the present invention, the instructions may relate to placing an order for a product or service.

In this manner, the additional information displayed on the device helps the user to further interact with the commercial by navigating through the various options available to the user. Thus, for example, the user can continue interacting with the commercial using a single click of a remote control, a connected Bluetooth keyboard mobile phone and so forth. By interacting with the commercial, the user is capable of performing one or more actions as desired, for example buying a product, placing an order, and the like.

In accordance with an embodiment of the present invention, the methodology of the present invention may be implemented by using TV Operating Systems and middleware such as Trickplay and Android. In accordance with another embodiment of the present invention, the methodology of the present invention may be implemented by using Smartphones. In accordance with a further embodiment of the present invention, the methodology of the present invention may be implemented by using SmartTV-enabled input devices, such as remote controls and connected Bluetooth keyboards. In accordance with an additional embodiment of the present invention, the methodology of the present invention may be implemented by using HTTP protocol.

It is understood that the sequence of steps described in the flowchart above is exemplary in nature and that it is used to facilitate the description of the invention. There may be other possible sequences of the steps that can be performed to implement the invention described in the present application. Accordingly, it is clear that that the invention is not limited to the embodiment described herein.

For the sake of simplicity and clarity, the invention will now be described with the help of an exemplary embodiment. According to this exemplary embodiment, it can be assumed that the user watches a live singing program. During the program, a commercial of an existing or an upcoming “TV show” is displayed. At the time of displaying the commercial, the TV operating system extracts an audio sample from this commercial and generates a fingerprint of for example, 3 seconds, 5 seconds, 7 seconds, 11 seconds or the like. Thereafter, the fingerprint is matched with fingerprints of one or more commercials present in a database.

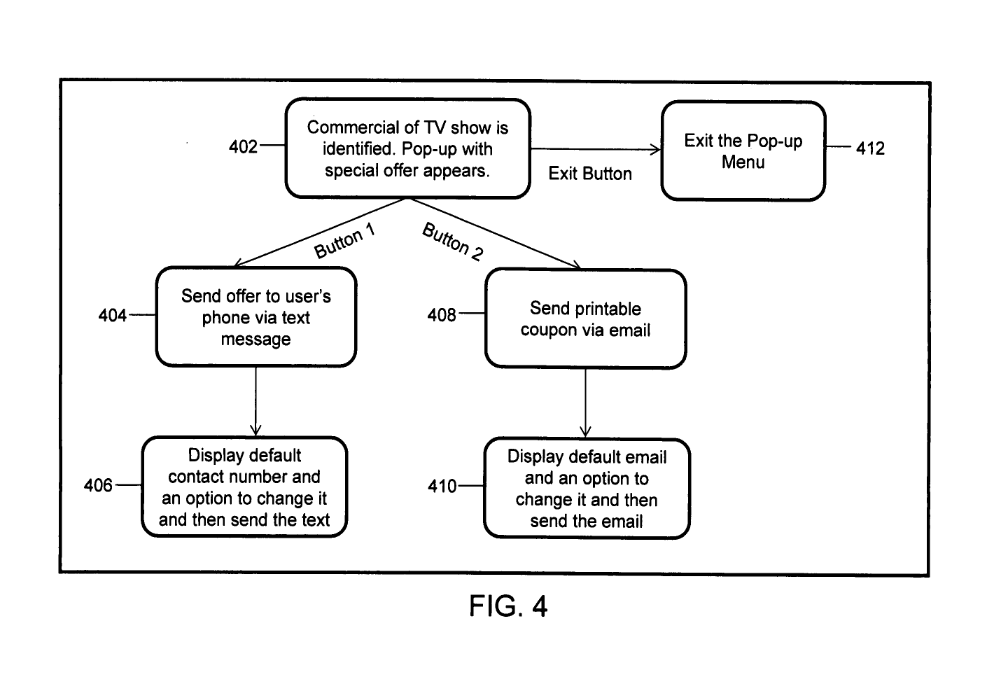

It can be assumed that the matching fingerprint of the commercial is found and accordingly, at 402 a pop-up menu with special offers as illustrated in FIG. 4 is displayed to the user on the TV. According to FIG. 4, three options are displayed to the user. These 3 options are enabled by pressing button 1, button 2, and the exit button, of a remote control of display device 104 (if applicable), mobile phones, keyboard, and the like. First option 404 includes instructions for sending an offer to user's mobile phone via text. Further, at 406 instructions for displaying a default contact number of the user are displayed and an option to change it and then sending the text to that default contact number. Second option 408 includes instructions for sending a printable coupon via email. In a similar manner, at 410 instructions for default email and an option to change it and then send the email are displayed. Third option 412 includes instructions for exiting the pop-up menu.

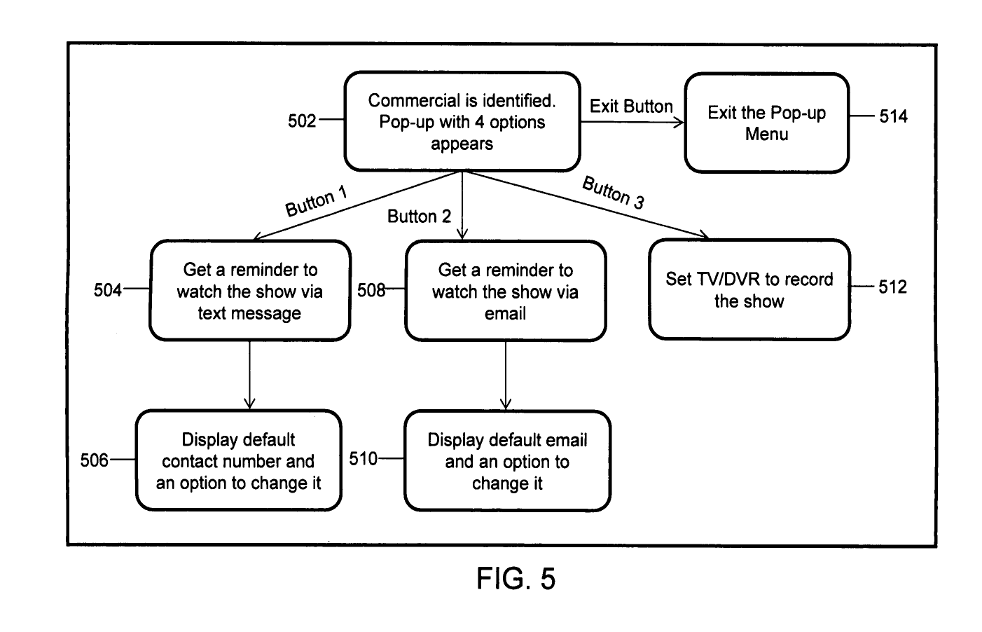

In accordance with another exemplary embodiment of the present invention as shown in FIG. 5, at 502 a pop-up menu with four options is displayed to the user. In a similar manner as discussed above, these options are enabled by pressing button 1, button 2, button 3, and the exit button, respectively. First option 504 includes instructions for receiving a reminder to watch the show via text message. Subsequently, at 506 instructions for displaying a default contact number and an option to change are displayed. Second option 508 includes instructions for receiving a reminder to watch the show via email. Similarly, at 510 instructions relating to displaying a default email and an option to change it are shown. Third option 512 includes instructions for recording the show on DVR/TV. Fourth option 514 includes exiting the pop-up menu.

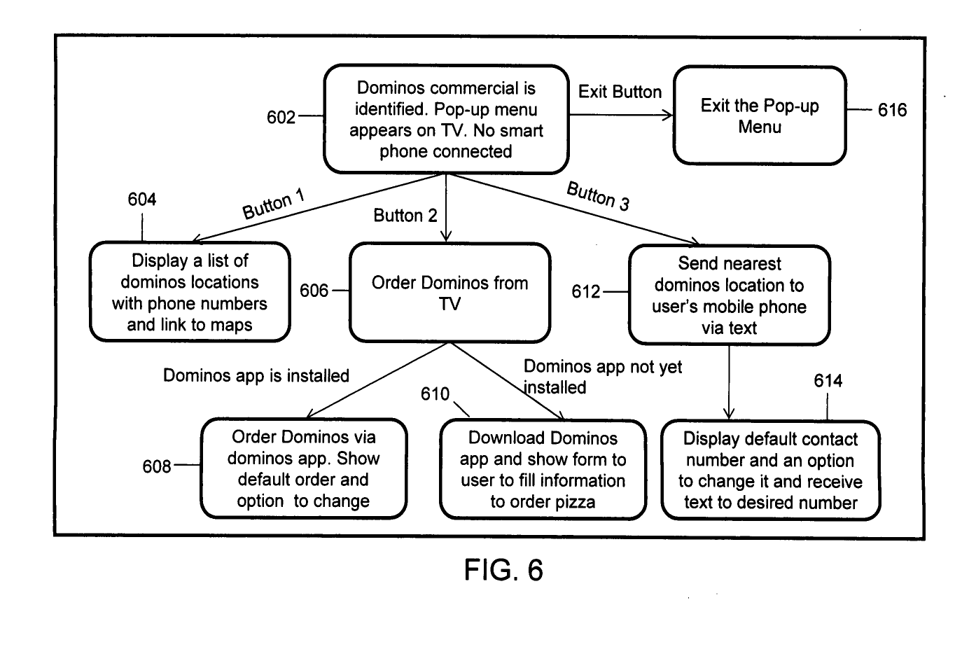

In accordance with a further exemplary embodiment of the present invention as shown in FIG. 6, at 602 a pop-up menu displaying 4 options appears on TV. This embodiment is described based on the assumption that a Domino's commercial is identified or matched with a set of commercials present in the database. According to this embodiment, no smart phone is connected. Further, first option 604 includes instructions for displaying a list of Domino's locations with phone numbers and links to maps. Second option 606 includes instructions for ordering Pizza from Domino's from a TV. Thereafter, a check is performed whether the Domino's application is installed. In case Domino's application is installed, instructions for ordering Domino's via Domino's app and show default order and an option to change it are displayed at 608. Otherwise, at 610, instructions for downloading Domino's app and show form for filling information to order Pizza are displayed to the user. Third option 612 includes instructions for sending the nearest Domino's location to the mobile phone of the user via text message. Subsequently, at 614 instructions for displaying a default contact number and an option to change it and receive text to the desired number are displayed. Lastly, at 616 instructions for cancelling or exiting the pop-up are displayed.

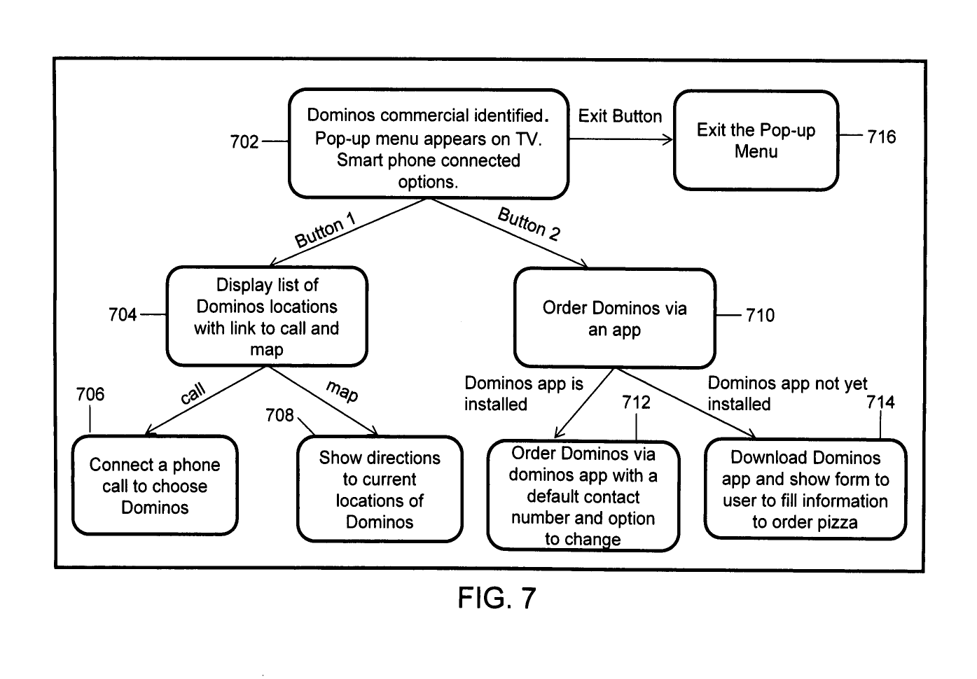

In accordance with an additional exemplary embodiment of the present invention, at 702 a pop-up menu as shown in FIG. 7 is displayed on TV, including instructions for connecting a smart phone of the user. This embodiment is described based on the assumption that Domino's commercial is identified or matched with a set of commercials present in the database. According to this embodiment, the pop-up menu displays three options. First option 704 includes displaying a list of Domino's locations with a link to call and a link to a map. In case the user wishes to call, instructions for connecting a phone call to choose Domino's are displayed at 706. In case the user chooses the map option, then instructions for showing directions to current locations of Domino's are displayed at 708. Second option 710 includes instructions for ordering pizza from Domino's via an application. If Domino's app is installed, the instructions for ordering pizza from Domino's app with a default contact number and an option to change it are displayed at 712. In case the Domino's app is not installed, the instructions for downloading Domino's app and a form for filling information to order the pizza are displayed at 714. Third option 716 includes cancelling the pop-up menu.

The present invention described above has numerous advantages. The present invention provides interactive commercials to users. The interactive commercials allow the users to easily perform one or more actions as desired. The present invention further enables the users to customize the commercials based on his/her needs. Further, the present invention enables the user to navigate through additional information such as coupons, websites, and other available media with a click of an input device and other similar devices. Moreover, the interactive commercials assure that the users pay attention to the commercials. Additionally, the interactive commercials allow the user to perform personalized deals.

The system and the method for facilitating interactive commercials, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method for the present invention.

The computer system typically comprises a computer, an input device, and a display unit. The computer typically comprises a microprocessor which is connected to a communication bus. The computer also includes a memory, which may include a Random Access Memory (RAM) and a Read Only Memory (ROM). Further, the computer system comprises a storage device, which can be a hard disk drive or a removable storage drive such as a floppy disk drive and an optical disk drive. The storage device can be other similar means for loading computer programs or other instructions into the computer system.

The computer system executes a set of instructions (or program instructions) that are stored in one or more storage elements to process input data. These storage elements can also hold data or other information, as desired and may be in the form of an information source or a physical memory element present in the processing machine. Exemplary storage elements include a hard disk, a DRAM, an SRAM, and an EPROM. The storage element may be external to the computer system and connected to or inserted into the computer, to be downloaded at or prior to the time of use. Examples of such external computer program products are computer-readable storage mediums such as CD-ROMS, Flash chips, and floppy disks.

The set of instructions (or program instruction means) may include various commands that instruct the processing machine to perform specific tasks such as the steps that constitute the method for the present invention. The set of instructions may be in the form of a software program. The software may be in various forms such as system software or application software. Further, the software may be in the form of a collection of separate programs, a program module with a large program, or a portion of a program module. The software may also include modular programming in the form of object-oriented programming. The software program that contains the set of instructions (a program instruction means) can be embedded in a computer program product for use with a computer, the computer program product comprising a computer-usable medium with a computer readable program code embodied therein. The processing of input data by the processing machine may be in response to users' commands, results of previous processing, or a request made by another processing machine.

The modules described herein may include processors and program instructions that are used to implement the functions of the modules described herein. Some or all the functions can be implemented by a state machine that has no stored program instructions, or in one or more Application-specific Integrated Circuits (ASICs), in which each function or some combinations of some of the functions are implemented as custom logic.

While the various embodiments of the invention have been illustrated and described, it will be clear that the invention is not limited only to these embodiments.

Numerous modifications, changes, variations, substitutions, and equivalents will be apparent to those skilled in the art, without departing from the spirit and scope of the invention.

What is claimed is:

1. A display device for displaying interactive commercials, the display device comprising:
a sampling module configured for sampling data from a commercial displayed to a user;
a fingerprinting module configured for generating a fingerprint of the sampled data; and
a display module configured for displaying an interactive content associated with the commercial, the interactive content being extracted based on the generated fingerprint.

2. The display device according to claim 1, wherein the data comprises at least one of: an audio, a video, text and a combination thereof.

3. The display device according to claim 1, wherein the sampling module samples the data at predefined time intervals.

4. The display device according to claim 1, wherein the sampling of the data is performed by an Application Program Interface (API).

5. The display device according to claim 1, wherein the fingerprint is generated in a pre-defined size segment.

6. The display device according to claim 1, wherein the interactive content is extracted by a server based on a match performed between the fingerprint and a plurality of fingerprints corresponding to a plurality of commercials stored in a database.

7. The display device according to claim 1, wherein the interactive content enables the user to perform one or more actions in real-time.

8. A server for providing interactive content, the server comprising:
a matching module configured for receiving a fingerprint corresponding to a commercial;
a database module configured to interact with the matching module for matching the fingerprint with a plurality of fingerprints corresponding to a plurality of commercials to obtain a matching fingerprint; and
an extracting module configured for extracting an interactive content associated with the matching fingerprint.

9. The server according to claim 8, wherein the interactive content is displayed with the commercial on a display device.

10. A method for providing interactive commercials, the method comprising:
sampling data from a commercial displayed to a user;
generating a fingerprint of the sampled data;
matching the generated fingerprint with a plurality of fingerprints corresponding to a plurality of commercials to obtain a matching fingerprint;
extracting an interactive content associated with the matching fingerprint; and
displaying the interactive content with the commercial, the interactive content enabling the user to perform one or more actions in real-time.

11. The method according to claim 10, wherein the data comprises at least one of:
an audio, a video, text and a combination thereof.

12. The method according to claim 10, wherein the sampling of the data is performed at predefined time intervals.

13. The method according to claim 10, wherein the fingerprint is generated in a pre-defined size segment.

14. The method according to claim 10, wherein the sampling, the fingerprinting and the matching is performed in a synchronized manner to provide the interactive content associated with the commercial at the time of display of the commercial.

15. A method for providing interactive commercials, the method comprising:
sampling data from a commercial displayed to a user;
generating a fingerprint of the sampled data;
matching the generated fingerprint with a plurality of fingerprints corresponding to a plurality of commercials to obtain a matching fingerprint;
extracting an interactive content associated with the matching fingerprint; and
displaying the interactive content in the form of one or more instructions to initiate an interaction of the user with the commercial.

16. The method according to claim 15, wherein the fingerprint is generated in a pre-defined size segment.

17. A computer program product for providing interactive commercials, said computer program product comprising a computer-readable storage medium having computer-readable program code instructions stored therein comprising:
instructions for sampling data from a commercial displayed to a user;
instructions for generating a fingerprint of the sampled data;
instructions for matching the generated fingerprint with a plurality of fingerprints corresponding to a plurality of commercials to obtain a matching fingerprint;
instructions for extracting an interactive content associated with the matching fingerprint; and
instructions for displaying the interactive content with the commercial, the interactive content enabling the user to perform one or more actions in real-time.
